(19) United States
(12) Patent Application Publication
(10) Pub. No.: US 2022/0237271 A1
(43) Pub. Date: Jul. 28, 2022

(54) AUTHENTICATION BASED ON PHYSICAL INTERACTION AND CHARACTERISTIC NOISE PATTERNS

(71) Applicant: Callsign Ltd., London (GB)

(72) Inventor: Yogesh Kumar Jitendra Patel, London (GB)

(21) Appl. No.: 17/158,954

(22) Filed: Jan. 26, 2021

(51) Int. Cl. G06F 21/32; G06F 21/35; G06F 21/60; G06K 9/62; G06N 20/00

(52) U.S. Cl. CPC G06F 21/32; G06F 21/35; G06N 20/00; G06K 9/6256; G06F 21/604

(57) ABSTRACT

Disclosed are systems, methods, and non-transitory computer-readable media for authentication based on physical interaction and characteristic noise patterns. Execution of a requested transaction may be conditioned upon satisfaction of an authentication requirement. For example, the requesting user may be prompted to perform a physical interaction such as a swipe across a screen of a client device. The sensor data includes a characteristic noise pattern caused by manufacturing deviations of the set of sensors that captured the sensor data. The sensor data describing the physical interaction and the characteristic noise pattern are used to determine whether the authentication requirement has been satisfied. For example, the sensor data and characteristic noise pattern are used to determine whether the user that performed the physical interaction is an authorized user. The authentication requirement is satisfied upon determining that the user that performed the physical interaction is an authorized user.

### TECHNICAL FIELD

An embodiment of the present subject matter relates generally to authentication and, more specifically, to authentication based on physical interaction and characteristic noise patterns.

### BACKGROUND

Current technology allows users to perform a wide variety of tasks by providing authentication for security. For example, online services (e.g., banking services, online retailer, etc.) allow users to access their bank accounts, transfer funds, access personal information, purchase items, etc., by simply providing a set of user credentials (e.g., username and password). While these types of online services provide convenience, they also create security concerns. For example, a bad actor with knowledge of the user credentials of another user (e.g., through phishing or social engineering) can access the other user's user bank account, transfer funds, etc. Accordingly, providing secure authentication is a growing concern.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a block diagram of a system for authentication based on physical interaction and characteristic noise patterns, in accordance with some example embodiments.

FIG. 2 is a communication diagram showing a service provider computing system operating as an intermediary between a client device and an authentication system 108 to provide authentication based on physical interaction and characteristic noise patterns, according to some example embodiments.

FIG. 3 is a communication diagram showing an authentication system 108 communicating directly with a client device to provide authentication based on physical interaction and characteristic noise patterns, according to some example embodiments.

FIG. 4 is a block diagram of an authentication system, according to some example embodiments.

FIG. 5 is a communication diagram showing an authentication system providing authentication based on physical interaction and characteristic noise patterns, according to some example embodiments.

FIG. 6 is a block diagram of an authentication analysis component, according to some example embodiments.

FIG. 7 is a flowchart showing a method for authentication based on physical interaction and characteristic noise patterns, according to certain example embodiments.

FIG. 8 is a flowchart showing a method for determining an authentication score, according to certain example embodiments.

FIGS. 9A-9D show a user interface for providing an authentication requirement based on a physical interaction, according to some example embodiments

FIG. 10 is a block diagram illustrating a representative software architecture, which may be used in conjunction with various hardware architectures herein described.

FIG. 11 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for authentication based on physical interaction and characteristic noise patterns. An authentication requirement (e.g., entering a username and password) can be implemented to authenticate a requested transaction. For example, a user requesting to perform a transaction, such as logging into an account, transferring funds, etc., may be prompted to satisfy an authentication requirement, such as entering a username and password, providing a code or personal identification number, answering a secret question, and the like. Approval and performance of the requested transaction may be contingent on the authentication requirement being properly satisfied. Accordingly, the requested transaction may be denied if the authentication requirement is not satisfied.

Common examples of an authentication requirement include providing a specified piece of data, such as a username/password, code, personal identification number (PIN), answer, and the like. One issue with these types of authentication requirements is that they can be satisfied by another user that has knowledge of the specified data. For example, a bad actor with knowledge of a username and password may simply use the username and password to perform a transaction, such as accessing email account, transferring funds, and the like. The effectiveness of the authentication requirement is therefore contingent on maintaining the privacy of the specified data.

To alleviate this issue, an authentication requirement may be based on a physical interaction. A physical interaction may be any type of physical movement or action, such as performing a swipe, moving a device in a specified motion, tapping on the device, and the like. In contrast to providing a specified piece of data, performance of a physical interaction may be unique to each user. That is, each person may perform a specified physical interaction in a manner that is unique to that person. For example, different people may perform a physical interaction such as swiping a finger across a screen in a unique manner by starting at different positions on the screen, using a different hand (e.g., right hand, left hand) to perform the swipe, following different trajectories, swiping at different speeds, ending at different positions, and the like. Different users may also hold a client device in different orientations when performing the swipe, further adding to the uniqueness of the physical interaction. Due to these unique qualities, a bad actor that is aware of the physical interaction to be performed (e.g., swiping from right to left) may still be unable to replicate the physical interaction sufficiently to satisfy the authentication requirement.

To implement an authentication requirement based on a physical interaction, a user is prompted to perform the physical interaction one or more times during an initial registration phase. Sensors are used to capture sensor data describing the physical interactions performed by the user during the initial registration phase. This sensor data can be stored and subsequently used as a reference during authentication requests to determine whether an authentication request has been satisfied. For example, the stored sensor data may be used as a reference of the known performance of the physical interaction by the authorized user.

After completion of the initial registration phase, a user requesting to perform a transaction may be prompted to perform the physical interaction as an authentication requirement. Sensors are again used to capture sensor data describing the physical interaction performed by the requesting user, which is then used along with the stored sensor data captured during the registration phase to determine whether the user requesting to perform the transaction is the authenticated user. For example, the sensor data captured during the authentication requirement may be analyzed to determine a set of user characteristics describing the specific manner in which the user performed the physical interaction. For example, the user characteristics may describe the speed, direction, starting/ending point, and other features of the physical interaction. The user characteristics of the physical interaction may then be compared to user characteristics of the known performance of the physical interaction by the authorized to determine whether the physical interaction was performed by the authorized user (e.g., whether the users characteristics match or are sufficiently similar).

In addition to the unique user characteristics of the authorized user's performance of the physical interaction, unique characteristics of the client device may also be used to authenticate a requesting user. For example, each client device may include physical variances and deviations caused during the manufacturing process. These deviations may be the result of varying solder points, minor defects in sensors, and the like. These manufacturing deviations result in a unique characteristic noise pattern being included in the sensor data captured by the client device.

During an authentication request, the characteristic noise pattern included in the sensor data can be used to determine whether the client device being used to perform the physical interaction is an expected client device, such as a client device of the authenticated user. For example, a characteristic noise pattern identified from the sensor data captured as part of the authentication requirement can be compared to a characteristic noise pattern identified from sensor data describing the known performance of the physical interaction by the authorized user. A determination that the characteristic noise patterns match or are sufficiently similar indicates that the client device used to perform the physical interaction is the client device of the authorized user.

In some embodiments, the user characteristics of a physical interaction and the noise characteristic patterns may be evaluated separately when determining whether an authentication requirement has been satisfied. For example, satisfaction of the authentication requirement may be based on each of the user characteristics and the noise characteristic patterns being separately satisfied. Alternatively, the user characteristics and the noise characteristic patterns may be evaluated in combination. For example, satisfaction of the authentication requirement may be based on a cumulative probability score determined based on the user characteristics and the noise characteristic pattern.

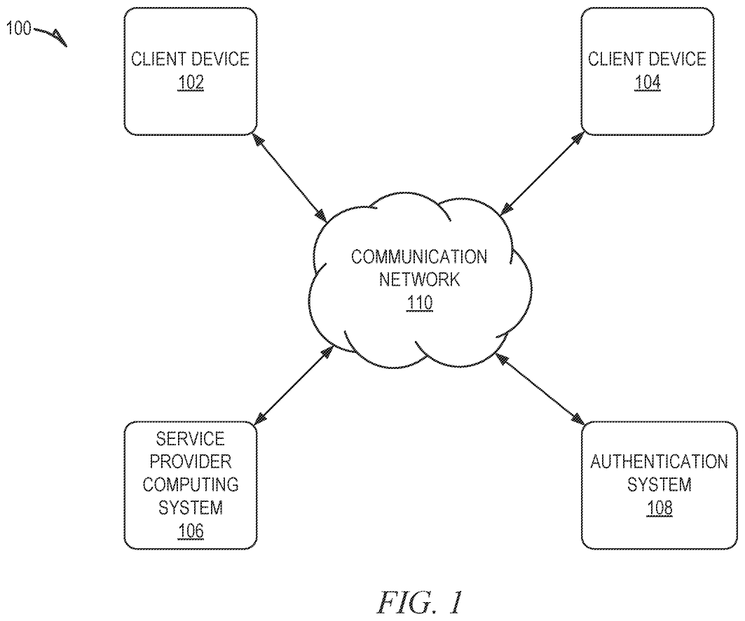

FIG. 1 is a block diagram of a system 100 for authentication based on physical interaction and characteristic noise patterns, in accordance with some example embodiments. As shown, multiple devices (i.e., client device 102, client device 104, service provider computing system 106, and an authentication system 108) are connected to a communication network 110 and configured to communicate with each other through use of the communication network 110. The communication network 110 is any type of network, including a local area network (LAN), such as an intranet, a wide area network (WAN), such as the internet, a telephone and mobile device network, such as cellular network, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

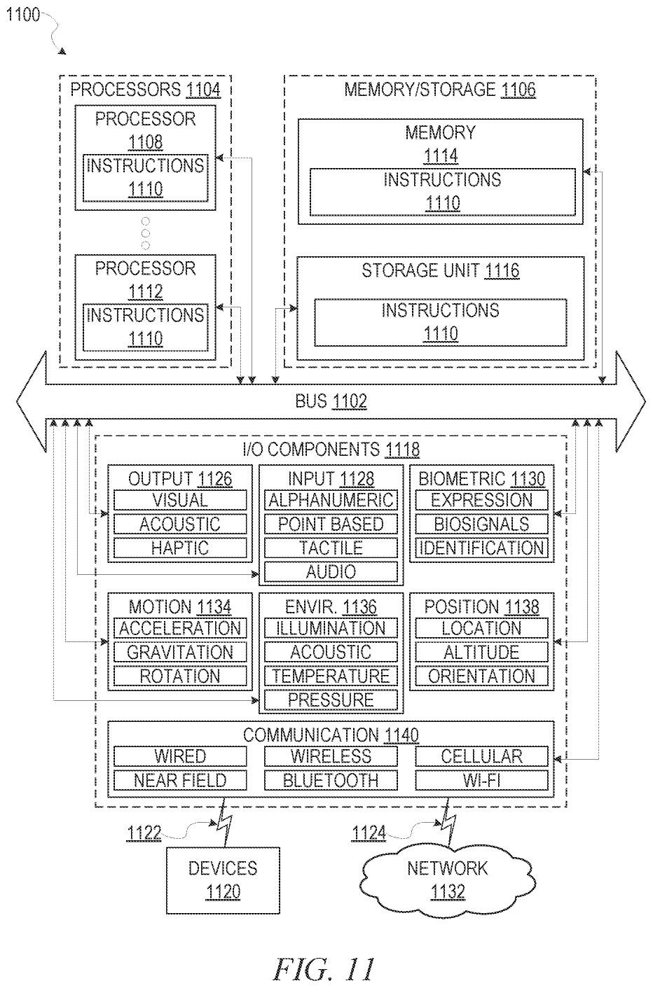

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 1100 shown in FIG. 11.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users may interact with a service provider computing system 106 to utilize services provided by a service provide. Users communicate with and utilize the functionality of the service provider computing system 106 by using the client devices 102 and 104 that are connected to the communication network 110 by direct and/or indirect communication. A service provider may provide any type of service, whether it be online or offline, and the service provider computing system 106 may facilitate any related service that is provided online, such as a banking service, online retailer, and the like.

Although the shown system 100 includes only two client devices 102, 104 and one service provider computing system 106, this is only for ease of explanation and is not meant to be limiting. One skilled in the art would appreciate that the system 100 can include any number of client devices 102, 104 and/or service provider computing system 106. Further, each service provider computing system 106 may concurrently accept communications from and initiate communication messages and/or interact with any number of client devices 102, 104, and support connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with a service provider computing system 106 via a client-side application installed on the client devices 102 and 104. In some embodiments, the client-side application includes a component specific to the service provider computing system 106. For example, the component may be a stand-alone application, one or more application plug-ins, and/or a browser extension. However, the users may also interact with the service provider computing system 106 via a third-party application, such as a web browser or messaging application, that resides on the client devices 102 and 104 and is configured to communicate with the service provider computing system 106. In either case, the client-side application presents a user interface (UI) for the user to interact with the service provider computing system 106. For example, the user interacts with the service provider computing system 106 via a client-side application integrated with the file system or via a webpage displayed using a web browser application.

A service provider computing system 106 is one or more computing devices associated with a service provider to provide functionality of the service provider. A service provider may be any type of business or entity that provides a service for customers. The service may be any type of online service and/or offline service, such as a banking service, travel service, retail service, and the like. The service provider computing system 106 may facilitate any online portion of the services provided by a service provider but does not have to provide an online service that is accessible to users. For example, the service provider computing system 106 may simply be a computing system used by a service provider to perform any type of functionality.

A service provider may enable its users/customers to perform various transactions as part of the services provided by the service provider. A transaction may be any of a variety of types of transaction, such as logging into an account, purchasing items, transferring money, accessing account data, and the like. A service provider may utilize the functionality of the authentication system 108 to authenticate requested transaction. For example, the authentication system 108 may provide authentication based on physical interaction and characteristic noise patterns. Although the authentication system 108 and the service provider computing system 106 are shown as separate entities, this is only one embodiment and is not meant to be limiting. In other embodiments, the functionality of the authentication system 108 may be partially or completely integrated within the service provider computing system 106.

The authentication system 108 communicates with the service provider computing system 106 and/or client device 102, 104 to provide for authentication based on physical interaction and characteristic noise patterns. For example, in some embodiments, the service provider computing system 106 operates as an intermediary between the client devices 102, 104 and the authentication system 108. In this type of embodiment, the service provider computing system 106 may receive sensor data from a client device 102, 104 describing a physical interaction performed by a user of the client device 102, 104, and pass the sensor data to the authentication system 108. The authentication system 108 uses the received sensor data to determine whether an authentication requirement has been satisfied and provides a response to the service provider computing system 106.

Alternatively, the authentication system 108 may communicate directly with a client device 102, 104 to collect sensor data. For example, the authentication system 108 may then use the received sensor data to determine whether an authentication requirement has been satisfied and provide a response to the service provider computing system 106.

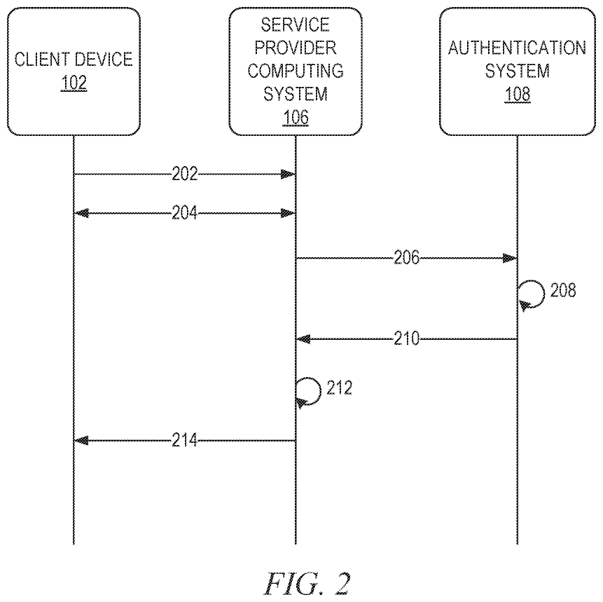

FIG. 2 is a communication diagram showing a service provider computing system 106 operating as an intermediary between a client device 102 and an authentication system 108 to provide authentication based on physical interaction and characteristic noise patterns, according to some example embodiments. As shown, the client device 102 transmits a transaction request 202 to the service provider computing system 106. The transaction request 202 may be a request to perform any type of transaction, such as logging into an account, transferring funds, and the like.

In response to receiving the transaction request 202, the service provider computing system 106 communicates 204 with the client device 102 to initiate an authentication process. This may include prompting the requesting user to provide specified data, such as a username and password. The authentication process may also include prompting the requesting user to perform a physical interaction, such as performing a swipe across a screen of the client device 102, shaking the client device 102, and the like. Sensors included in the client device 102 may gather sensor data describing performance of the physical interaction, which is provided to the service provider computing system 106.

In turn, the service provider computing system 106 transmits an authentication request 206 to the authentication system 108. The authentication request 206 may include the sensor data received from the client device 102. The authentication request 206 may also include data identifying the requesting user, such as an account identifier associated with the requesting user and/or data identifying the client device 102.

The authentication system 108 uses the received sensor data to perform an authentication analysis 208 to determine whether the authentication requirement has been satisfied. For example, the authentication system 108 uses the sensor data to determine whether user characteristics describing features of the physical interaction match or are sufficiently similar to user characteristics describing features of the known performance of the physical interaction by an authorized user. The authentication system 108 may also identify a characteristic noise pattern included in the sensor data to determine whether the authentication requirement has been satisfied. For example, the characteristic noise pattern can indicate whether the client device 102 being used to perform the physical interaction is an expected client device 102 such as a client device 102 known to be associated with the authenticated user.

After performing the authentication analysis 208, the authentication system 108 provides a response 210 to the service provider computing system 106. The response 210 indicates the outcome of the authentication analysis 208, such as indicating whether the authentication requirement has or has not been satisfied. In turn, the service provider computing system 106 may approve or deny the requested transaction based on the response 210. For example, the service provider computing system 106 may approve the requested transaction if the authorization requirement has been satisfied or deny the requested transaction if the authorization requirement has not been satisfied. In the event that the requested transaction is approved, the service provider computing system 106 may execute 212 the requested transaction. For example, the service provider computing system 106 may execute a login to an account, execute a transfer of funds, and the like. The service provider computing system 106 may communicate 214 with the client device 102 to provide the client device 102 with any subsequent data resulting from execution of the requested transaction. For example, the service provider computing system 106 may provide the client device 102 with a notification that the requested transaction has been completed, any requested data (e.g., financial data), and the like.

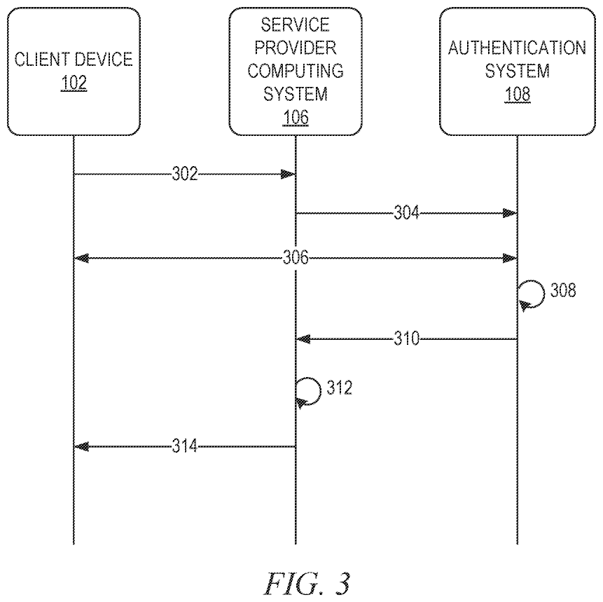

FIG. 3 is a communication diagram showing an authentication system 108 communicating directly with a client device 102 to provide authentication based on physical interaction and characteristic noise patterns, according to some example embodiments. As shown, the client device 102 transmits a transaction request 302 to the service provider computing system 106. The transaction request 302 may be a request to perform any type of transaction, such as logging into an account, transferring funds, and the like.

In turn, the service provider computing system 106 transmits an authentication request 304 to the authentication system 108. The authentication request may include data identifying the requesting user, such as an account identifier associated with the requesting user and/or data identifying the client device 102, such as phone number.

The authentication system 108 communicates 306 with the client device 102 to initiate an authentication process. For example, the authentication system 108 may transmit a message (e.g., short message service (SMS) message) to the client device 102 that prompts the requesting user to perform a physical interaction, such as performing a swipe across a screen of the client device 102, shaking the client device 102, and the like. Sensors included in the client device 102 may gather sensor data describing performance of the physical interaction, which is then provided to the authentication system 108 as part of the communications 306.

The authentication system 108 uses the received sensor data to perform an authentication analysis 308 to determine whether the authentication requirement has been satisfied. For example, the authentication system 108 uses the sensor data to determine whether user characteristics describing features of the physical interaction match or are sufficiently similar to user characteristics describing features of the known performance of the physical interaction by an authorized user. The authentication system 108 may also identify a characteristic noise pattern included in the sensor data to determine whether the authentication requirement has been satisfied. For example, the characteristic noise pattern can indicate whether the client device 102 being used to perform the physical interaction is an expected client device 102 such as a client device 102 known to be associated with the authenticated user.

After performing the authentication analysis 308, the authentication system 108 provides a response 310 to the service provider computing system 106. The response 310 indicates the outcome of the authentication analysis 308, such as indicating whether the authentication requirement has or has not been satisfied. In turn, the service provider computing system 106 may approve or deny the requested transaction based on the response 310. For example, the service provider computing system 106 may approve the requested transaction if the authorization requirement has been satisfied or deny the requested transaction if the authorization requirement has not been satisfied. In the event that the requested transaction is approved, the service provider computing system 106 may execute 312 the requested transaction. For example, the service provider computing system 106 may execute a login to an account, execute a transfer of funds, and the like. The service provider computing system 106 may communicate 314 with the client device 102 to provide the client device 102 with any subsequent data resulting from execution of the requested transaction. For example, the service provider computing system 106 may provide the client device 102 with a notification that the requested transaction has been completed, any requested data (e.g., financial data), and the like.

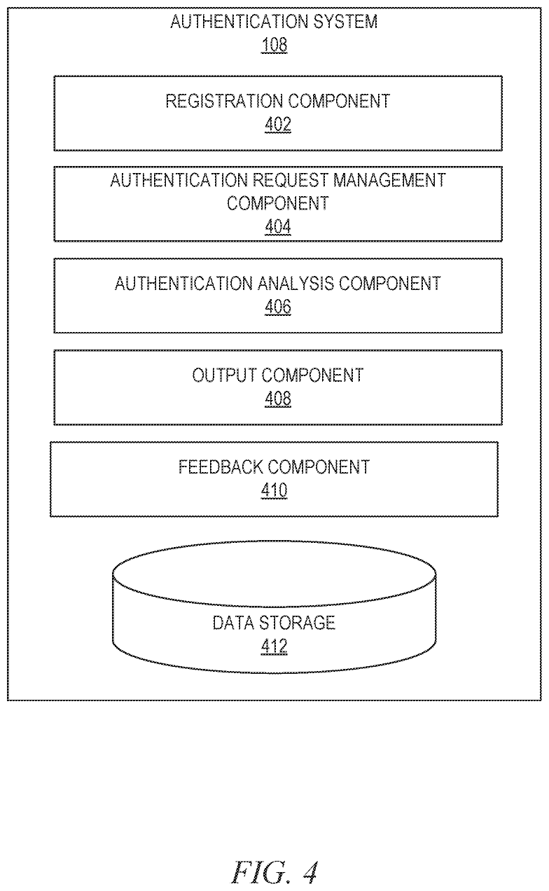

FIG. 4 is a block diagram of an authentication system 108, according to some example embodiments. To avoid obscuring the inventive subject matter with unnecessary detail, various functional components (e.g., modules) that are not germane to conveying an understanding of the inventive subject matter have been omitted from FIG. 4. However, a skilled artisan will readily recognize that various additional functional components may be supported by the authentication system 108 to facilitate additional functionality that is not specifically described herein. Furthermore, the various functional modules depicted in FIG. 4 may reside on a single computing device or may be distributed across several computing devices in various arrangements such as those used in cloud-based architectures.

As shown, the authentication system 108 includes a registration component 402, an authentication request management component 404, an authentication analysis component 406, an output component 408, a feedback component 410, and a data storage 412.

The registration component 402 facilitates an initial registration phase for implementing an authentication requirement based on a physical interaction. As explained previously, user characteristics describing the unique qualities of a user's performance of a physical interaction as well as a characteristic noise pattern associated with a user's client device 102 can be used to authenticate that a user requesting to perform a transaction is an authorized user. To implement an authentication requirement based on a physical interaction, the registration component 402 facilitates an initial registration phase during with a user is prompted to perform the physical interaction one or more times. The physical interaction may be any type of physical action or movement that can be captured by sensors. For example, the physical interaction may be performing a movement across a touchscreen of a client device 102, such as a swipe or other motion, shaking a client device 102, moving arms in a pattern, and the like.

In some embodiments, the physical interaction may be a predetermined physical interaction that the user is prompted to perform, such as performing a specified swipe or motion. Alternatively, in some embodiments, the physical interaction may be selected by the registering user. For example, the user may be prompted to perform a physical interaction of the user's choice, such as by performing any desired motion across a touch screen of the client device 102, moving the client device 102 in a specified pattern, entering a personal identification number (PIN), and the like.

Sensors included in the client device 102 are used to capture sensor data describing the physical interactions performed by the user during the registration phase. The client device 102 may include any of a variety of types of sensors that may be used to capture sensor data describing the physical interaction. For example, the sensors may include optical sensors (e.g., cameras), audio sensors (e.g., microphones, motion sensors, touch sensors (e.g., touchscreens), accelerometers, and the like.

The client device 102 provides the sensor data captured during the registration phase to the authentication system 108. The registration component 402 stores the sensor data in the data storage 412, where it may be associated with the registering user and/or client device 102. For example, the sensor data may be associated with a unique user identifier associated with the user and/or device identifier associated with the client device 102, such as a phone number. The stored sensor data may be used subsequently during authentication requests to determine whether a user requesting to perform a transaction is the authenticated user (e.g., the user that performed the physical interactions during the registration phase).

In some embodiments, the registration component 402 may perform some additional processing of the sensor data. For example, the registration component 402 may generate user characteristics describing the physical interaction. The user characteristics may be a feature vector representing the physical interaction performed by the user based on the sensor data. The feature vector may include individual values determined based on specified features describing the physical interaction. For example, the feature vector may include values indicating a starting and/or ending point of motion, a speed of a motion, a direction of a motion, a trajectory of a motion, and the like. In some embodiments, the registration component 402 may use the user characteristics to generate a machine learning model. For example, the registration component 402 may use the user characteristics generated from the sensor data as training data used to train a machine learning algorithm. The resulting machine learning model may provide an output probability score indicating a likelihood that a physical interaction was performed by the authorized user. For example, sensor data describing the physical interaction and/or user characteristics (e.g., feature vector) generated from the sensor data may be used as input into the trained machine learning model, which in turn provides an output probability score.

In some embodiments, the registration component 402 may identify a characteristic noise pattern included in the sensor data captured during the registration phase. Each client device 102 may include physical variances and deviations caused during the manufacturing process. These deviations may be the result of varying solder points, minor defects in sensors, and the like. These manufacturing deviations result in a unique characteristic noise pattern being included in the sensor data captured by the client device 102. The registration component 402 may analyze the sensor data to identify the characteristic noise pattern associated with the client device 102 used during the registration phase, which may be used subsequently during authentication requests to determine whether a user requesting to perform a transaction is the authenticated user (e.g., the user that performed the physical interactions during the registration phase).

Similar to the sensor data, the registration component 402 may generate feature vectors and/or train a machine learning model based on the characteristic noise pattern. For example, the feature vector may include individual values determined based on specified features describing the characteristic noise pattern. Further, the registration component 402 may use the characteristic noise pattern and/or feature vectors generated from the characteristic noise pattern as training data used to train a machine learning algorithm. The resulting machine learning model may provide an output probability score indicating a likelihood that a physical interaction was performed by the client device 102 used during the registration phase. For example, sensor data describing a characteristic noise pattern identified from sensor data captured as part of an authentication request and/or a feature vector generated from the characteristic noise pattern may be used as input into the trained machine learning model, which in turn provides an output probability score.

The authentication request management component 404 receives and processes authentication requests. An authentication request is a request to authenticate whether a user requesting to perform a transaction is authorized to perform the transaction. For example, the requesting user may be authenticated based on whether an authentication requirement including a physical interaction has been satisfied.

The authentication request management component 404 may receive an authentication request from the service provider computing system 106. The authentication request may include data identifying an account, authorized user and or client device 102. For example, the authentication request may include a unique identifier associated with a user and/or account.

In some embodiments, the authentication request may include sensor data describing a physical interaction performed by a requesting user to satisfy an authentication requirement. For example, the service provider computing system 106 may facilitate communications with a client device 102 of the requesting user to prompt the user to perform the physical interaction and receive sensor data describing the physical interaction. In this type of embodiments, the authentication request management component 404 may provide the sensor data and other data included in the authentication request to the authentication analysis component 406.

Alternatively, in some embodiments, the authentication request management component 404 may facilitate performance of the physical interaction by the requesting user and collection of the sensor data. For example, the authentication request management component 404 may transmit a message (e.g. SMS message) to the client device 102 of the requesting user that prompts the requesting user to perform the physical interaction. The message may include a user interface element, such as a button, that when actuated causes the client device 102 to enable the user to perform the physical interaction and/or collect sensor data to capture the physical interaction. The client device 102 returns the sensor data to the authentication system 108, which is received by the authentication request management component 404. In turn, the authentication request management component 404 may provide the sensor data and other data included in the authentication request to authentication analysis component 406.

The authentication analysis component 406 uses the received sensor data to determine whether the requesting user is the authorized user. For example, the authentication analysis component 406 uses the sensor data describing the physical interaction performed by the requesting user along with the stored sensor data captured during the registration phase to determine whether the user requesting to perform the transaction is the authenticated user. This may be accomplished in several ways, such as by generating user characteristics (e.g., feature vector) describing the physical interaction from the sensor data received from the client device 102 and comparing the user characteristics to user characteristics generated from the sensor data stored in the data storage 412. As another example, the sensor data received from the client device 102 may be used as input into a machine learning model trained based on the sensor data captured during the registration phase, resulting in a probability score indicating the likelihood that the physical interaction was performed by the authorized user. The authentication analysis component 406 may then determine whether the user requesting to perform the transaction is the authenticated user based on the probability score.

The authentication analysis component 406 may similarly use a characteristic noise pattern included in the sensor data to determine whether the user requesting to perform the transaction is the authenticated user. For example, the authentication analysis component 406 may generate a feature vector from the characteristic noise pattern, which is analyzed in relation to a feature vector generated from a characteristic noise pattern included in the sensor data captured during the registration phase. As another example, authentication analysis component 406 may be use the characteristic noise pattern as input into a machine learning model trained based on the sensor data captured during the registration phase. The authentication analysis component 406 may use the resulting probability score to determine whether the user requesting to perform the transaction is the authenticated user based on the probability score.

In some embodiments, the authentication analysis component 406 may evaluate the user characteristics describing the physical interaction and the noise characteristic patterns separately when determining whether an authentication requirement has been satisfied. For example, satisfaction of the authentication requirement may be based on each of the user characteristics describing the physical interaction and the noise characteristic patterns being separately satisfied. Alternatively, the user characteristics describing the physical interaction and the noise characteristic patterns may be evaluated in combination. For example, satisfaction of the authentication requirement may be based on a cumulative probability score determined based on the user characteristics describing the physical interaction and the noise characteristic pattern.

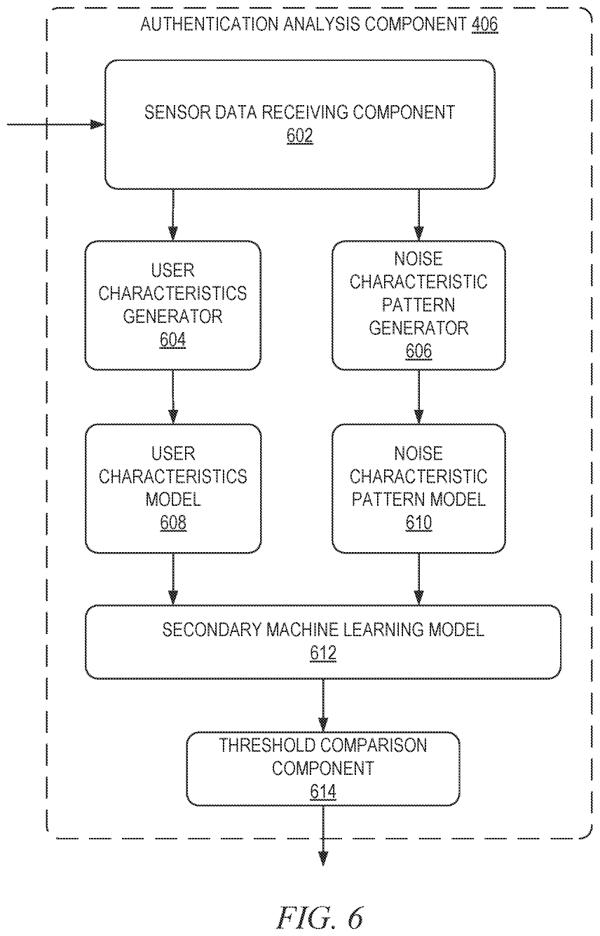

The functionality of the authentication analysis component 406 is discussed in greater detail below in relation to FIG. 6. The authentication analysis component 406 notifies the output component 408 indicating whether the physical interaction was determined to have been performed by the authorized user. In turn, the output component 408 transmits a response message to the service provider computing system 106 indicating whether the authorization requirement was satisfied. For example, if the authentication analysis component 406 determines that the physical interaction was performed by the authorized user, the output component 408 transmits a response message to the service provider computing system 106 indicating that the authorization requirement is satisfied. Alternatively, if the authentication analysis component 406 determines that the physical interaction was not performed by the authorized user, the output component 408 transmits a response message to the service provider computing system 106 indicating that the authorization requirement is not satisfied.

The feedback component 410 received feedback data describing performance of the authentication system 108. For example, the feedback data may indicate whether the authentication system 108 correctly identified whether a physical interaction was performed by an authorized user. The feedback component 410 may use the received feedback data to further refine performance of the authentication system 108. For example, the feedback data may be used generate additional training data to refine machine learning models used by the authentication system 108.

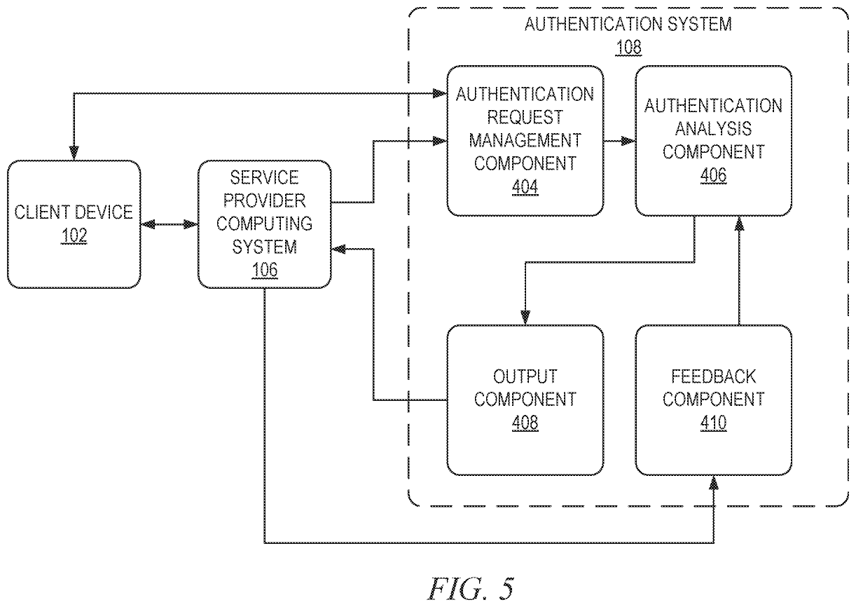

FIG. 5 is a communication diagram showing an authentication system 108 providing authentication based on physical interaction and characteristic noise patterns, according to some example embodiments. As shown, a client device 102 may communicate with a service provider computing system 106. For example, the client device 102 may communicate with the service provider computing system 106 to utilize an online service provided by the service provider computing system 106. This may include requesting to perform transactions, such as logging into an account, transferring funds, and the like.

The service provider computing system 106 communicates with the authentication system 108 to authenticate requested transactions. For example, performance of a requested transaction may be conditioned upon satisfaction of an authentication requirement by a requesting user, such as the user performing a physical interaction. The authentication system 108 determines whether an authentication requirement based on a physical interaction has been satisfied. For example, the authentication system 108 uses sensor data captured by the client device 102 that describes the physical interaction as well as stored sensor data describing the physical interaction performed by an authorized user to determine whether the user requesting to perform the transaction is the authorized user.

The service provider computing system 106 transmits an authentication request to the authentication system 108 to initiate the authentication process. The authentication request is received by the authentication request management component 404 of the authentication system 108. The authentication request may include data describing the requesting user, such as unique user identifier, device identifier, and the like. The authentication request may also include sensor data describing performance of the physical interaction by the requesting user. Alternatively, the authentication request management component 404 may communicate with the client device 102 to prompt the requesting user to perform the physical interaction. The client device 102 captures sensor data describing the physical interaction, which is returned to the authentication system 108 and received by the authentication request management component 404.

The authentication request management component 404 provides the sensor data and other data received in the authentication request to the authentication analysis component 406. The authentication analysis component 406 uses the sensor data to determine whether the physical interaction was performed by the authorized user. The determination may be based on user characteristics describing the physical interaction as well as a characteristic noise pattern identified from the sensor data. The authentication analysis component 406 provides a notification to the output component 408 indicating whether the physical interaction was determined to have been performed by the authorized user.

In turn, the output component 408 provides a response message to the service provider computing system 106 indicating whether the authentication requirement has been satisfied. For example, the output component 408 transmits a response message indicating that the authentication requirement has been satisfied if the physical interaction was determined to have been performed by the authorized user. Alternatively, the output component 408 transmits a response message indicating that the authentication requirement has not been satisfied if the physical interaction was determined to have not been performed by the authorized user.

The service provider computing system 106 may process the requested transaction based on the response message received from the output component 408. For example, the service provider computing system 106 may approve (e.g., execute) the requested transaction if the response message indicates that the authentication request has been satisfied. Alternatively, the service provider computing system 106 may deny the requested transaction if the response message indicates that the authentication request has not been satisfied.

The service provider computing system 106 may provide the authentication system 108 with feedback data that is received by the feedback component 410. The feedback data may indicate whether the determination provided by authentication system 108 was correct or incorrect. For example, the feedback data may indicate that the authentication system 108 incorrectly determined that the authentication requirement had been satisfied or had not been satisfied. Alternatively, the feedback data may indicate that the authentication system 108 correctly determined that the authentication requirement had been satisfied or had not been satisfied. The feedback data may include data identifying the requested transaction to which it pertains.

The received feedback data may be used to further refine performance of the authentication system 108. For example, the feedback component 410 may use the feedback data and the corresponding sensor data to further train machine learning models used by the authentication analysis component 406. As another example, the feedback component 410 may use the feedback data and the corresponding sensor data to identify additional features describing the physical interaction and/or the characteristic noise pattern for identifying whether a physical interaction was performed by the authorized user. In some embodiments, the feedback component 410 may avoid the use of outlier data points when training the machine learning models, which may reduce the rate of false acceptances and rejections.

FIG. 6 is a block diagram of an authentication analysis component 406, according to some example embodiments. To avoid obscuring the inventive subject matter with unnecessary detail, various functional components (e.g., modules) that are not germane to conveying an understanding of the inventive subject matter have been omitted from FIG. 6. However, a skilled artisan will readily recognize that various additional functional components/devices may be supported by the authentication analysis component 406 to facilitate additional functionality that is not specifically described herein. Furthermore, the various functional components/devices depicted in FIG. 6 may reside on a single computing device or may be distributed across several computing devices in various arrangements such as those used in cloud-based architectures

As shown, the authentication analysis component 406 includes a sensor data receiving component 602, a user characteristics generator 604, a noise characteristic pattern generator 608, a user characteristics model 608, a noise characteristic pattern model 610, a secondary machine learning model 612, and a threshold comparison component 614.

The sensor data receiving component 602 receives sensor data describing a physical interaction performed by a user requesting to perform an interaction. For example, the sensor data receiving component 602 receives the sensor data from the authentication request management component 404. The sensor data may have been collected by sensors of a client device 102 used to request a transaction. For example, the user of the client device 102 may have been prompted to perform the physical interaction as an authentication requirement to execute the requested transaction. The sensor data receiving component 602 provides the received sensor data to the user characteristic generator 604 and the noise characteristic pattern generator 606.

The user characteristic generator 604 uses the sensor data received from the sensor data receiving component 602 to generate user characteristics describing the physical interaction performed as part of the authentication requirement. The user characteristics may be a feature vector that represents the physical interaction performed by the user requesting to perform the transaction.

The noise characteristic pattern generator 606 generates a noise characteristic pattern from the sensor data. Each client device 102 may include physical variances and deviations caused during the manufacturing process. These deviations may be the result of varying solder points, minor defects in sensors, electrical components, and the like. These manufacturing deviations result in a unique noise characteristic pattern being included in the sensor data captured by the client device 102. For example, the unique characteristic noise pattern may be represented in binary value deviation in digital or as voltage deviation in analogue chipsets.

The user characteristics generated by the user characteristics generator 604 and the noise characteristic pattern generated by the noise characteristic pattern generator 606 are both used to determine whether a physical interaction was performed by an authorized user. For example, the user characteristics generator 604 provides an input to the user characteristics model 608 based on the user characteristics generated from the sensor data and the noise characteristic pattern generator 606 provides an input to the noise characteristic pattern model 610 based on the noise characteristic pattern generated from the sensor data.

Both the user characteristics model 608 and the noise characteristic pattern model 610 are machine learning models generated based on sensor describing known physical interactions performed by the authorized user. For example, the sensor data may have been captured from the authorized user during a registration phase. The user characteristics model 608 and the noise characteristic pattern model 610 may also be subsequently retrained or refined based on sensor data subsequently captured during authentication request that were confirmed to have been or not have been performed by the authorized user. For example, the service provider computing system 106 may provide the authentication system 108 with feedback data indicating whether a physical interaction was confirmed to have or have not been performed by the authorized user. The associated sensor data may then be used as training data to further refine the user characteristics model 608 and the noise characteristic pattern model 610.

The user characteristics model 608 is trained based on user characterizes describing a physical interaction. Accordingly, the trained user characteristics model 608 receives an input of a user characteristics representing a physical interaction and outputs a physical interaction score indicating the likelihood that the physical interaction was performed by the authorized user.

The noise characteristic pattern model 610 is trained based on noise characteristic patterns identified from the sensor data describing the physical interaction. Accordingly, the noise characteristic pattern model 610, once trained, receives an input representing a noise characteristic pattern and outputs a sensor score indicating the likelihood that the physical interaction was performed by the client device 102 associated with the authorized user.

The authentication system 108 determines whether a physical interaction was performed by the authorized user based on a combination of the physical interaction score and the sensor score. For example, an input generated based on the physical interaction score and the sensor score are provided as input into a secondary machine learning model 612. The secondary machine learning model 612 is a machine learning model that is trained based on the output of the user characteristics model 608 and the noise characteristic pattern model 610. Accordingly, the secondary machine learning model 612 receives an input based on a combination of the physical interaction score and the sensor score and outputs an authentication score indicating a likelihood that the physical interaction was performed by the authorized user.

The resulting authentication score is provided to the threshold comparison component 614. The threshold comparison component 614 compares the authentication score to a threshold authentication score to determine whether the physical interaction was performed by the authorized user. For example, the threshold comparison component 614 determines that the physical interaction was performed by the authorized user when the authorization score meets or exceeds the threshold authentication score. Alternatively, the threshold comparison component 614 determines that the physical interaction was not performed by the authorized user when the authorization score is below the threshold authentication score. The threshold comparison component 614 may provide it output to other component of the authentication system 108, such as the output component 408.

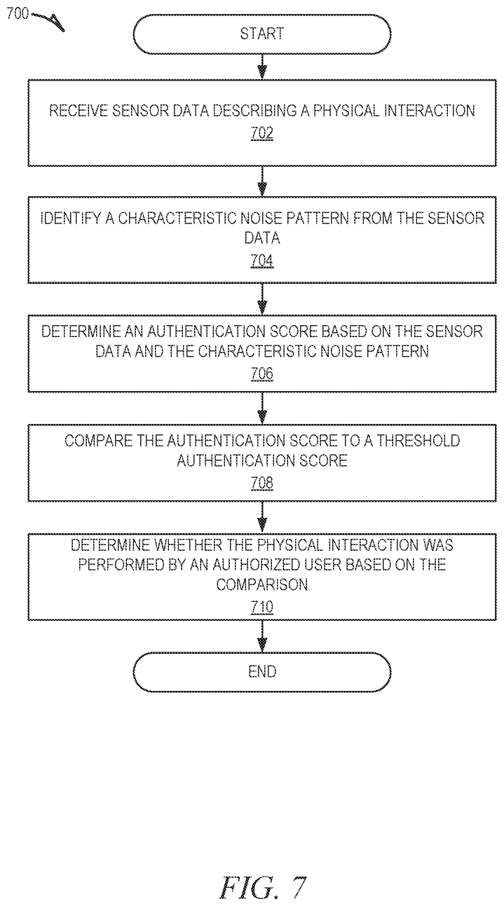

FIG. 7 is a flowchart showing a method 700 for authentication based on physical interaction and characteristic noise patterns, according to certain example embodiments. The method 700 may be embodied in computer readable instructions for execution by one or more processors such that the operations of the method 700 may be performed in part or in whole by the authentication analysis component 406; accordingly, the method 700 is described below by way of example with reference thereto. However, it shall be appreciated that at least some of the operations of the method 700 may be deployed on various other hardware configurations and the method 700 is not intended to be limited to the authentication analysis component 406.

At operation 702, the sensor data receiving component 602 receives sensor data describing a physical interaction. For example, the sensor data receiving component 602 receives the sensor data from the authentication request management component 404. The sensor data may have been collected by sensors of a client device 102 used to request a transaction. For example, the user of the client device 102 may have been prompted to perform the physical interaction as an authentication requirement to execute the requested transaction. The sensor data receiving component 602 provides the received sensor data to the user characteristic generator 604 and the noise characteristic pattern generator 606.

At operation 704, the noise characteristic pattern generator 606 identifies (e.g., generates) a characteristic noise pattern from the sensor data. Each client device 102 may include physical variances and deviations caused during the manufacturing process. These deviations may be the result of varying solder points, minor defects in sensors, electrical components, and the like. These manufacturing deviations result in a unique characteristic noise pattern being included in the sensor data captured by the client device 102. The noise characteristic pattern generator 606 identifies a noise characteristic pattern from the sensor data, which can be used along with the sensor data describing the physical interaction to determine whether the physical interaction was performed by an authorized user.

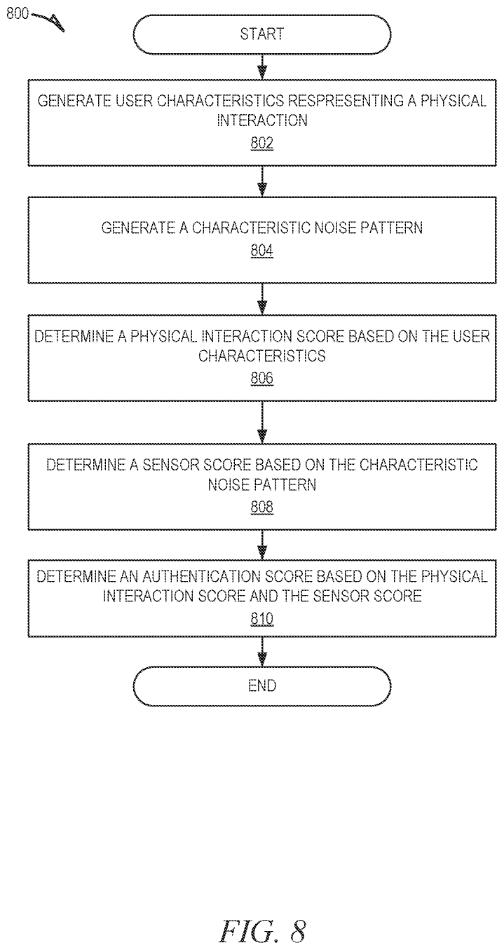

At operation 706, the authentication analysis component 406 determines an authentication score based on the sensor data and the characteristic noise pattern. For example, the authentication analysis component 406 may determine the authentication score using the method 800 described below in relation to FIG. 8.

At operation 708, the threshold comparison component 614 compares the authentication score to the threshold authentication score. The threshold comparison component 614 compares the authentication score to a threshold authentication score to determine whether the physical interaction was performed by the authorized user.

At operation 710, the threshold comparison component 614 determines whether the physical interaction was performed by an authorized user based on the comparison. For example, the threshold comparison component 614 determines that the physical interaction was performed by the authorized user when the authorization score meets or exceeds the threshold authentication score. Alternatively, the threshold comparison component 614 determines that the physical interaction was not performed by the authorized user when the authorization score is below the threshold authentication score. The threshold comparison component 614 may provide it output to other component of the authentication system 108, such as the output component 408.

FIG. 8 is a flowchart showing a method 800 for determining an authentication score, according to certain example embodiments. The method 800 may be embodied in computer readable instructions for execution by one or more processors such that the operations of the method 800 may be performed in part or in whole by the authentication analysis component 406; accordingly, the method 800 is described below by way of example with reference thereto. However, it shall be appreciated that at least some of the operations of the method 800 may be deployed on various other hardware configurations and the method 800 is not intended to be limited to the authentication analysis component 406.

At operation 802, the user characteristics generator 604 generates user characteristic representing a physical interaction. For example, user characteristic generator 604 uses sensor data received from the sensor data receiving component 602 to generate user characteristics describing the physical interaction performed as part of the authentication requirement. The user characteristics may be a feature vector that represents the physical interaction performed by the user requesting to perform the transaction.

At operation 804, the noise characteristic pattern generator 606 generates a characteristic noise pattern. Each client device 102 may include physical variances and deviations caused during the manufacturing process. These deviations may be the result of varying solder points, minor defects in sensors, electrical components, and the like. These manufacturing deviations result in a unique noise characteristic pattern being included in the sensor data captured by the client device 102. For example, the unique characteristic noise pattern may be represented in binary value deviation in digital or as voltage deviation in analogue chipsets.

At operation 806, user characteristics model 608 determines a physical interaction score based on the user characteristics, and at operation 808, the noise characteristic pattern model 610 determines a sensor score based on the characteristic noise pattern. Both the user characteristics model 608 and the noise characteristic pattern model 610 are machine learning models generated based on sensor describing known physical interactions performed by the authorized user. The user characteristics model 608 receives an input of the user characteristics representing the physical interaction and outputs the physical interaction score indicating the likelihood that the physical interaction was performed by the authorized user. Similarly, the noise characteristic pattern model 610 receives an input representing a noise characteristic pattern and outputs a sensor score indicating the likelihood that the physical interaction was performed by the client device 102 associated with the authorized user.

At operation 810, the secondary machine learning model 612 determines an authentication score based on the physical interaction score and the sensor score. The secondary machine learning model 612 is a machine learning model that is trained based on the output of the user characteristics model 608 and the noise characteristic pattern model 610 during a training phase. The secondary machine learning model 612 receives an input based on a combination of the physical interaction score and the sensor score and outputs the authentication score indicating a likelihood that the physical interaction was performed by the authorized user.

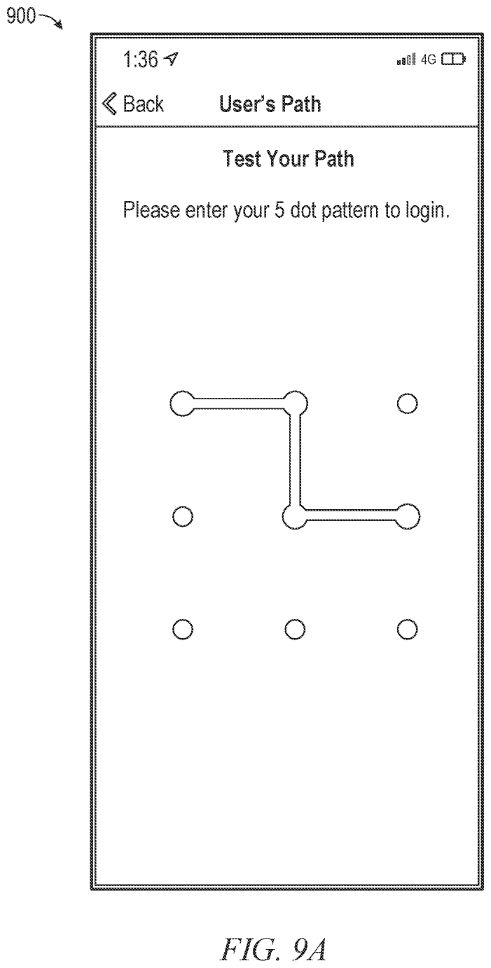

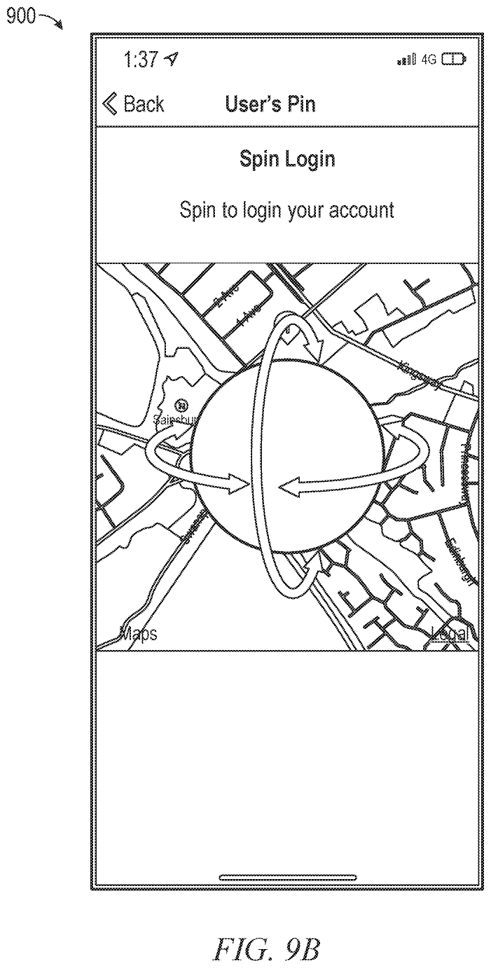

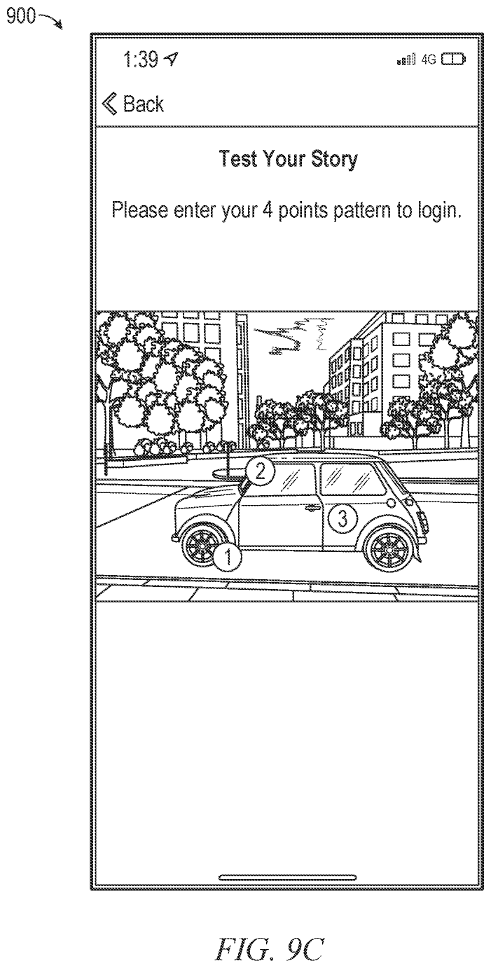

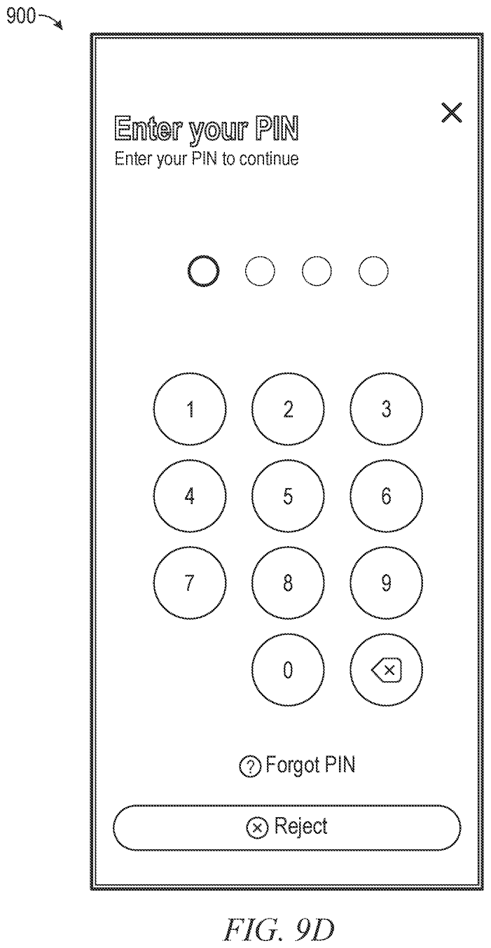

FIGS. 9A-9D show a user interface for providing an authentication requirement based on a physical interaction, according to some example embodiments. As shown in FIG. 9A, the user interface 900 prompts the user to perform a physical interaction by swiping a path connecting some of the presented dots. The path may be selected by the user or assigned to the user during an initiation phase. To perform the physical interaction, the user may use an input device, such as a touchscreen or mouse, to perform the path across the shown dots. While the user interface shows the specified path to be followed, this is only for illustrative purposes. In practice, the path may be shown or concealed when presented to the user during an authentication request.

As shown in FIG. 9B, the user interface 900 prompts the user to perform a physical interaction by spinning a circle presented on the screen. The pattern in which the user is to spin the circle may be selected by the user or assigned to the user during an initiation phase. To perform the physical interaction, the user may use an input device, such as a touchscreen or mouse, to rotate (e.g., spin) the circle in the specified pattern.

As shown in FIG. 9C, the user interface 900 prompts the user to perform a physical interaction by entering a pattern of multiple points over a presented image. The pattern and/or specified points may be selected by the user or assigned to the user during an initiation phase. To perform the physical interaction, the user may use an input device, such as a touchscreen or mouse, to provide an input at specified point and in a desired order. While the user interface shows the specified points and order to be entered, this is only for illustrative purposes. In practice, the points and order may be shown or concealed when presented to the user during an authentication request.

As shown in FIG. 9D, the user interface 900 prompts the user to perform a physical interaction by entering a specified PIN. The PIN the user is to enter may be selected by the user or assigned to the user during an initiation phase. To perform the physical interaction, the user may use an input device, such as a touchscreen or mouse, to select from the presented numbers to form the PIN.

### Software Architecture

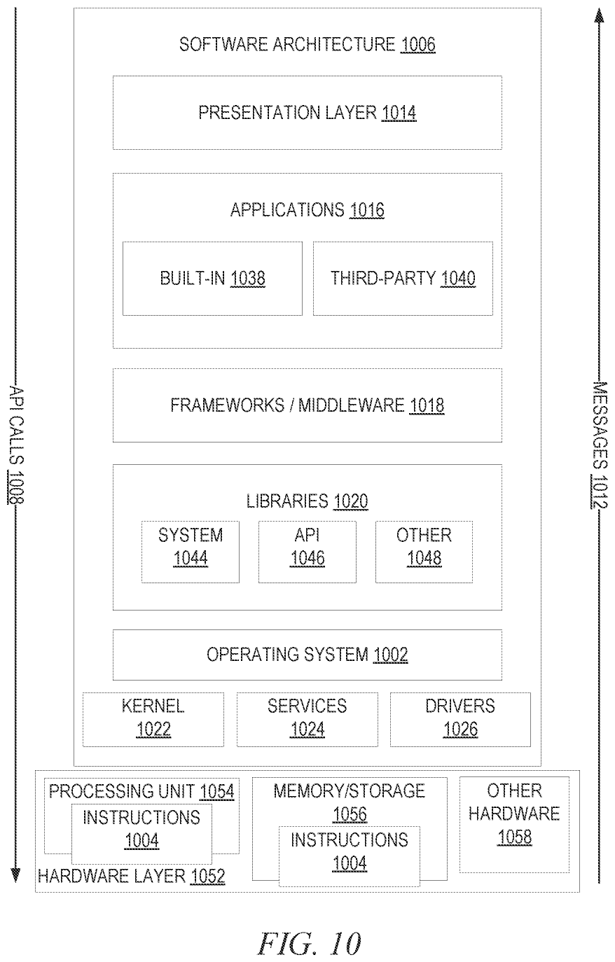

FIG. 10 is a block diagram illustrating an example software architecture 1006, which may be used in conjunction with various hardware architectures herein described. FIG. 10 is a non-limiting example of a software architecture 1006 and it will be appreciated that many other architectures may be implemented to facilitate the functionality described herein. The software architecture 1006 may execute on hardware such as machine 1100 of FIG. 11 that includes, among other things, processors 1104, memory 1114, and (input/output) I/O components 1118. A representative hardware layer 1052 is illustrated and can represent, for example, the machine 1100 of FIG. 11. The representative hardware layer 1052 includes a processing unit 1054 having associated executable instructions 1004. Executable instructions 1004 represent the executable instructions of the software architecture 1006, including implementation of the methods, components, and so forth described herein. The hardware layer 1052 also includes memory and/or storage modules 1056, which also have executable instructions 1004. The hardware layer 1052 may also comprise other hardware 1058.

In the example architecture of FIG. 10, the software architecture 1006 may be conceptualized as a stack of layers where each layer provides particular functionality. For example, the software architecture 1006 may include layers such as an operating system 1002, libraries 1020, frameworks/middleware 1018, applications 1016, and a presentation layer 1014. Operationally, the applications 1016 and/or other components within the layers may invoke application programming interface (API) calls 1008 through the software stack and receive a response such as messages 1012 in response to the API calls 1008. The layers illustrated are representative in nature and not all software architectures have all layers. For example, some mobile or special purpose operating systems may not provide a frameworks/middleware 1018, while others may provide such a layer. Other software architectures may include additional or different layers.

The operating system 1002 may manage hardware resources and provide common services. The operating system 1002 may include, for example, a kernel 1022, services 1024, and drivers 1026. The kernel 1022 may act as an abstraction layer between the hardware and the other software layers. For example, the kernel 1022 may be responsible for memory management, processor management (e.g., scheduling), component management, networking, security settings, and so on. The services 1024 may provide other common services for the other software layers. The drivers 1026 are responsible for controlling or interfacing with the underlying hardware. For instance, the drivers 1026 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 1020 provide a common infrastructure that is used by the applications 1016 and/or other components and/or layers. The libraries 1020 provide functionality that allows other software components to perform tasks in an easier fashion than to interface directly with the underlying operating system 1002 functionality (e.g., kernel 1022, services 1024, and/or drivers 1026). The libraries 1020 may include system libraries 1044 (e.g., C standard library) that may provide functions such as memory allocation functions, string manipulation functions, mathematical functions, and the like. In addition, the libraries 1020 may include API libraries 1046 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1020 may also include a wide variety of other libraries 1048 to provide many other APIs to the applications 1016 and other software components/modules.

The frameworks/middleware 1018 (also sometimes referred to as middleware) provide a higher-level common infrastructure that may be used by the applications 1016 and/or other software components/modules. For example, the frameworks/middleware 1018 may provide various graphical user interface (GUI) functions, high-level resource management, high-level location services, and so forth. The frameworks/middleware 1018 may provide a broad spectrum of other APIs that may be used by the applications 1016 and/or other software components/modules, some of which may be specific to a particular operating system 1002 or platform.

The applications 1016 include built-in applications 1038 and/or third-party applications 1040. Examples of representative built-in applications 1038 may include, but are not limited to, a contacts application, a browser application, a book reader application, a location application, a media application, a messaging application, and/or a game application. Third-party applications 1040 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 1040 may invoke the API calls 1008 provided by the mobile operating system (such as operating system 1002) to facilitate functionality described herein.

The applications 1016 may use built in operating system functions (e.g., kernel 1022, services 1024, and/or drivers 1026), libraries 1020, and frameworks/middleware 1018 to create UIs to interact with users of the system. Alternatively, or additionally, in some systems, interactions with a user may occur through a presentation layer, such as presentation layer 1014. In these systems, the application/component “logic” can be separated from the aspects of the application/component that interact with a user.

FIG. 11 is a block diagram illustrating components of a machine 1100, according to some example embodiments, able to read instructions 1004 from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1110 (e.g., software, a program, an application, an applet, an app, or other executable code) for causing the machine 1100 to perform any one or more of the methodologies discussed herein may be executed. As such, the instructions 1110 may be used to implement modules or components described herein. The instructions 1110 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 1100 capable of executing the instructions 1110, sequentially or otherwise, that specify actions to be taken by machine 1100. Further, while only a single machine 1100 is illustrated, the term “machine” shall also be taken to include a collection of machines that individually or jointly execute the instructions 1110 to perform any one or more of the methodologies discussed herein.

The machine 1100 may include processors 1104, memory/storage 1106, and I/O components 1118, which may be configured to communicate with each other such as via a bus 1102. The memory/storage 1106 may include a memory 1114, such as a main memory, or other memory storage, and a storage unit 1116, both accessible to the processors 1104 such as via the bus 1102. The storage unit 1116 and memory 1114 store the instructions 1110 embodying any one or more of the methodologies or functions described herein. The instructions 1110 may also reside, completely or partially, within the memory 1114, within the storage unit 1116, within at least one of the processors 1104 (e.g., within the processor's cache memory), or any suitable combination thereof, during execution thereof by the machine 1100. Accordingly, the memory 1114, the storage unit 1116, and the memory of processors 1104 are examples of machine-readable media.

The I/O components 1118 may include a wide variety of components to receive input, provide output, produce output, transmit information, exchange information, capture measurements, and so on. The specific I/O components 1118 that are included in a particular machine 1100 will depend on the type of machine. For example, portable machines such as mobile phones will likely include a touch input device or other such input mechanisms, while a headless server machine will likely not include such a touch input device. It will be appreciated that the I/O components 1118 may include many other components that are not shown in FIG. 11. The I/O components 1118 are grouped according to functionality merely for simplifying the following discussion and the grouping is in no way limiting. In various example embodiments, the I/O components 1118 may include output components 1126 and input components 1128. The output components 1126 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1128 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1118 may include biometric components 1130, motion components 1134, environmental components 1136, or position components 1138 among a wide array of other components. For example, the biometric components 1130 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1134 may include acceleration sensor components (e.g., accelerometer), gravitation sensor components, rotation sensor components (e.g., gyroscope), and so forth. The environmental components 1136 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1138 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1118 may include communication components 1140 operable to couple the machine 1100 to a network 1132 or devices 1120 via coupling 1124 and coupling 1122, respectively. For example, the communication components 1140 may include a network interface component or other suitable device to interface with the network 1132. In further examples, communication components 1140 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1120 may be another machine or any of a wide variety of peripheral devices (e.g., a peripheral device coupled via a USB).

Moreover, the communication components 1140 may detect identifiers or include components operable to detect identifiers. For example, the communication components 1140 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1140 such as location via Internet Protocol (IP) geo-location, location via Wi-Fi® signal triangulation, location via detecting a NFC beacon signal that may indicate a particular location, and so forth.

“CARRIER SIGNAL” in this context refers to any intangible medium that is capable of storing, encoding, or carrying instructions 1110 for execution by the machine 1100, and includes digital or analog communications signals or other intangible medium to facilitate communication of such instructions 1110. Instructions 1110 may be transmitted or received over the network 1132 using a transmission medium via a network interface device and using any one of a number of well-known transfer protocols.

“CLIENT DEVICE” in this context refers to any machine 1100 that interfaces to a communications network 1132 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 1132.

“COMMUNICATIONS NETWORK” in this context refers to one or more portions of a network 1132 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 1132 or a portion of a network 1132 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 1110 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 1110. The term “machine-readable medium” shall also be taken to include any medium, or combination of multiple media, that is capable of storing instructions 1110 (e.g., code) for execution by a machine 1100, such that the instructions 1110, when executed by one or more processors 1104 of the machine 1100, cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” refers to “non-transitory” machine-readable mediums and excludes signals or other “transitory” computer readable mediums. A “non-transitory” machine-readable medium is a physical device that can store data for a period of time during which the stored data may be transferrable or reproducible. Examples of a non-transitory machine-readable medium are a physical memory device, Random Access Memory (RAM), etc. In contrast, transitory machine-readable mediums are not physical and store data only momentarily, such as a signal.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 1104) may be configured by software (e.g., an application 1016 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 1104 or other programmable processor 1104. Once configured by such software, hardware components become specific machines 1100 (or specific components of a machine 1100) uniquely tailored to perform the configured functions and are no longer general-purpose processors 1104. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 1104 configured by software to become a special-purpose processor, the general-purpose processor 1104 may be configured as respectively different special-purpose processors (e.g., comprising different hardware components) at different times. Software accordingly configures a particular processor or processors 1104, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 1102) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 1104 that are temporarily configured (e.g., by software) or permanently configured to perform the relevant operations. Whether temporarily or permanently configured, such processors 1104 may constitute processor-implemented components that operate to perform one or more operations or functions described herein. As used herein, “processor-implemented component” refers to a hardware component implemented using one or more processors 1104. Similarly, the methods described herein may be at least partially processor-implemented, with a particular processor or processors 1104 being an example of hardware. For example, at least some of the operations of a method may be performed by one or more processors 1104 or processor-implemented components. Moreover, the one or more processors 1104 may also operate to support performance of the relevant operations in a “cloud computing” environment or as a “software as a service” (SaaS). For example, at least some of the operations may be performed by a group of computers (as examples of machines 1100 including processors 1104), with these operations being accessible via a network 1132 (e.g., the Internet) and via one or more appropriate interfaces (e.g., an API). The performance of certain of the operations may be distributed among the processors 1104, not only residing within a single machine 1100, but deployed across a number of machines 1100. In some example embodiments, the processors 1104 or processor-implemented components may be located in a single geographic location (e.g., within a home environment, an office environment, or a server farm). In other example embodiments, the processors 1104 or processor-implemented components may be distributed across a number of geographic locations.

“PROCESSOR” in this context refers to any circuit or virtual circuit (a physical circuit emulated by logic executing on an actual processor 1104) that manipulates data values according to control signals (e.g., “commands,” “op codes,” “machine code,” etc.) and which produces corresponding output signals that are applied to operate a machine 1100. A processor 1104 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 1104 may further be a multi-core processor having two or more independent processors 1104 (sometimes referred to as “cores”) that may execute instructions 1110 contemporaneously.

### Non-Limiting Examples

Example 1 is a method comprising: receiving sensor data captured by a set of sensors of a client device, the sensor data describing a physical interaction with the client device that was performed as part of an authentication request; identifying a characteristic noise pattern from the sensor data, the characteristic noise pattern caused by manufacturing deviations of the set of sensors that captured the sensor data; determining an authentication score based on the sensor data describing the physical interaction with the client device and the characteristic noise pattern, the authentication score indicating a likelihood that the physical interaction was performed by an authenticated user; and determining whether to approve an authentication request based on a comparison of the authentication score to a threshold authentication score.

In Example 2, the subject matter of Example 1 includes, wherein determining the authentication score comprises: determining a physical interaction score based on the sensor data describing the physical interaction with the client device and historical sensor data describing physical interactions performed by the authenticated user; determining a sensor score based on the characteristic noise pattern identified from the sensor data and historical characteristic noise patterns identified from the historical sensor data describing physical interactions performed by the authenticated user; and determining the authentication score based on the physical interaction score and the sensor score.

In Example 3, the subject matter of Examples 1-2 includes, wherein determining the physical interaction score comprises: generating a first input based on the sensor data describing the physical interaction with the client device; and providing the first input into a first machine learning model, yielding the physical interaction score, the first machine learning model having been trained based on the historical sensor data describing physical interactions performed by the authenticated user.

In Example 4, the subject matter of Examples 1-3 includes, wherein determining the sensor score comprises: generating a second input based on the characteristic noise pattern identified from the sensor data; and providing the second input into a second machine learning model, yielding the sensor score, the second machine learning model having been trained based on the historical characteristic noise patterns identified from the historical sensor data describing physical interactions performed by the authenticated user.

In Example 5, the subject matter of Examples 1-4 includes, wherein determining the authentication score based on the physical interaction score and the sensor score comprises: generating a third input based on the physical interaction score and the sensor score; and providing the third input into a third machine learning model, yielding the authentication score, the third machine learning model having been trained based on the historical sensor data describing physical interactions performed by the authenticated user and the historical characteristic noise patterns identified from the historical sensor data describing physical interactions performed by the authenticated user.

In Example 6, the subject matter of Examples 1-6 includes, wherein determining whether to approve the authentication request based on the comparison of the authentication score to the threshold authentication score comprises: in response to determining that the authentication score exceeds the threshold authentication score, approving the authentication request.

In Example 7, the subject matter of Examples 1-6 includes, wherein determining whether to approve the authentication request based on the comparison of the authentication score to the threshold authentication score comprises: in response to determining that the authentication score is less than the threshold authentication score, denying the authentication request.

Example 8 is a system comprising: one or more computer processors; and one or more computer-readable mediums storing instructions that, when executed by the one or more computer processors, cause the system to perform operations comprising: receiving sensor data captured by a set of sensors of a client device, the sensor data describing a physical interaction with the client device that was performed as part of an authentication request; identifying a characteristic noise pattern from the sensor data, the characteristic noise pattern caused by manufacturing deviations of the set of sensors that captured the sensor data; determining an authentication score based on the sensor data describing the physical interaction with the client device and the characteristic noise pattern, the authentication score indicating a likelihood that the physical interaction was performed by an authenticated user; and determining whether to approve an authentication request based on a comparison of the authentication score to a threshold authentication score.

In Example 9, the subject matter of Example 8 includes, wherein determining the authentication score comprises: determining a physical interaction score based on the sensor data describing the physical interaction with the client device and historical sensor data describing physical interactions performed by the authenticated user; determining a sensor score based on the characteristic noise pattern identified from the sensor data and historical characteristic noise patterns identified from the historical sensor data describing physical interactions performed by the authenticated user; and determining the authentication score based on the physical interaction score and the sensor score.

In Example 10, the subject matter of Examples 8-9 includes, wherein determining the physical interaction score comprises: generating a first input based on the sensor data describing the physical interaction with the client device; and providing the first input into a first machine learning model, yielding the physical interaction score, the first machine learning model having been trained based on the historical sensor data describing physical interactions performed by the authenticated user.

In Example 11, the subject matter of Example 8-10 includes, wherein determining the sensor score comprises: generating a second input based on the characteristic noise pattern identified from the sensor data; and providing the second input into a second machine learning model, yielding the sensor score, the second machine learning model having been trained based on the historical characteristic noise patterns identified from the historical sensor data describing physical interactions performed by the authenticated user.

In Example 12, the subject matter of Examples 8-11 includes, wherein determining the authentication score based on the physical interaction score and the sensor score comprises: generating a third input based on the physical interaction score and the sensor score; and providing the third input into a third machine learning model, yielding the authentication score, the third machine learning model having been trained based on the historical sensor data describing physical interactions performed by the authenticated user and the historical characteristic noise patterns identified from the historical sensor data describing physical interactions performed by the authenticated user.

In Example 13, the subject matter of Examples 8-12 includes, wherein determining whether to approve the authentication request based on the comparison of the authentication score to the threshold authentication score comprises: in response to determining that the authentication score exceeds the threshold authentication score, approving the authentication request.

In Example 14, the subject matter of Examples 8-13 includes, wherein determining whether to approve the authentication request based on the comparison of the authentication score to the threshold authentication score comprises: in response to determining that the authentication score is less than the threshold authentication score, denying the authentication request.

Example 15 is a non-transitory computer-readable medium storing instructions that, when executed by one or more computer processors of one or more computing devices, cause the one or more computing devices to perform operations comprising: receiving sensor data captured by a set of sensors of a client device, the sensor data describing a physical interaction with the client device that was performed as part of an authentication request; identifying a characteristic noise pattern from the sensor data, the characteristic noise pattern caused by manufacturing deviations of the set of sensors that captured the sensor data; determining an authentication score based on the sensor data describing the physical interaction with the client device and the characteristic noise pattern, the authentication score indicating a likelihood that the physical interaction was performed by an authenticated user; and determining whether to approve an authentication request based on a comparison of the authentication score to a threshold authentication score.

In Example 16, the subject matter of Example 15 includes, wherein determining the authentication score comprises: determining a physical interaction score based on the sensor data describing the physical interaction with the client device and historical sensor data describing physical interactions performed by the authenticated user; determining a sensor score based on the characteristic noise pattern identified from the sensor data and historical characteristic noise patterns identified from the historical sensor data describing physical interactions performed by the authenticated user; and determining the authentication score based on the physical interaction score and the sensor score.

In Example 17, the subject matter of Examples 15-16 includes, wherein determining the physical interaction score comprises: generating a first input based on the sensor data describing the physical interaction with the client device; and providing the first input into a first machine learning model, yielding the physical interaction score, the first machine learning model having been trained based on the historical sensor data describing physical interactions performed by the authenticated user.

In Example 18, the subject matter of Examples 15-17 includes, wherein determining the sensor score comprises: generating a second input based on the characteristic noise pattern identified from the sensor data; and providing the second input into a second machine learning model, yielding the sensor score, the second machine learning model having been trained based on the historical characteristic noise patterns identified from the historical sensor data describing physical interactions performed by the authenticated user.

In Example 19, the subject matter of Examples 115-18 includes, wherein determining the authentication score based on the physical interaction score and the sensor score comprises: generating a third input based on the physical interaction score and the sensor score; and providing the third input into a third machine learning model, yielding the authentication score, the third machine learning model having been trained based on the historical sensor data describing physical interactions performed by the authenticated user and the historical characteristic noise patterns identified from the historical sensor data describing physical interactions performed by the authenticated user.

In Example 20, the subject matter of Examples 15-19 includes, wherein determining whether to approve the authentication request based on the comparison of the authentication score to the threshold authentication score comprises: in response to determining that the authentication score exceeds the threshold authentication score, approving the authentication request.

What is claimed is:

1. A method comprising:
receiving sensor data captured by a set of sensors of a client device, the sensor data describing a physical interaction with the client device that was performed as part of an authentication request;
identifying a characteristic noise pattern from the sensor data, the characteristic noise pattern caused by manufacturing deviations of the set of sensors that captured the sensor data;
determining an authentication score based on the sensor data describing the physical interaction with the client device and the characteristic noise pattern, the authentication score indicating a likelihood that the physical interaction was performed by an authenticated user; and
determining whether to approve an authentication request based on a comparison of the authentication score to a threshold authentication score.

2. The method of claim 1, wherein determining the authentication score comprises:
determining a physical interaction score based on the sensor data describing the physical interaction with the client device and historical sensor data describing physical interactions performed by the authenticated user;
determining a sensor score based on the characteristic noise pattern identified from the sensor data and historical characteristic noise patterns identified from the historical sensor data describing physical interactions performed by the authenticated user; and
determining the authentication score based on the physical interaction score and the sensor score.

3. The method of claim 2, wherein determining the physical interaction score comprises:
generating a first input based on the sensor data describing the physical interaction with the client device; and
providing the first input into a first machine learning model, yielding the physical interaction score, the first machine learning model having been trained based on the historical sensor data describing physical interactions performed by the authenticated user.

4. The method of claim 3, wherein determining the sensor score comprises:
generating a second input based on the characteristic noise pattern identified from the sensor data; and
providing the second input into a second machine learning model, yielding the sensor score, the second machine learning model having been trained based on the historical characteristic noise patterns identified from the historical sensor data describing physical interactions performed by the authenticated user.

5. The method of claim 4, wherein determining the authentication score based on the physical interaction score and the sensor score comprises:
generating a third input based on the physical interaction score and the sensor score; and
providing the third input into a third machine learning model, yielding the authentication score, the third machine learning model having been trained based on the historical sensor data describing physical interactions performed by the authenticated user and the historical characteristic noise patterns identified from the historical sensor data describing physical interactions performed by the authenticated user.

6. The method of claim 1, wherein determining whether to approve the authentication request based on the comparison of the authentication score to the threshold authentication score comprises:
in response to determining that the authentication score exceeds the threshold authentication score, approving the authentication request.

7. The method of claim 1, wherein determining whether to approve the authentication request based on the comparison of the authentication score to the threshold authentication score comprises:
in response to determining that the authentication score is less than the threshold authentication score, denying the authentication request.

8. A system comprising:
one or more computer processors; and
one or more computer-readable mediums storing instructions that, when executed by the one or more computer processors, cause the system to perform operations comprising:
receiving sensor data captured by a set of sensors of a client device, the sensor data describing a physical interaction with the client device that was performed as part of an authentication request;
identifying a characteristic noise pattern from the sensor data, the characteristic noise pattern caused by manufacturing deviations of the set of sensors that captured the sensor data;
determining an authentication score based on the sensor data describing the physical interaction with the client device and the characteristic noise pattern, the authentication score indicating a likelihood that the physical interaction was performed by an authenticated user; and
determining whether to approve an authentication request based on a comparison of the authentication score to a threshold authentication score.

9. The system of claim 8, wherein determining the authentication score comprises:
determining a physical interaction score based on the sensor data describing the physical interaction with the client device and historical sensor data describing physical interactions performed by the authenticated user;
determining a sensor score based on the characteristic noise pattern identified from the sensor data and historical characteristic noise patterns identified from the historical sensor data describing physical interactions performed by the authenticated user; and
determining the authentication score based on the physical interaction score and the sensor score.

10. The system of claim 9, wherein determining the physical interaction score comprises:
generating a first input based on the sensor data describing the physical interaction with the client device; and
providing the first input into a first machine learning model, yielding the physical interaction score, the first machine learning model having been trained based on the historical sensor data describing physical interactions performed by the authenticated user.

11. The system of claim 10, wherein determining the sensor score comprises:
generating a second input based on the characteristic noise pattern identified from the sensor data; and
providing the second input into a second machine learning model, yielding the sensor score, the second machine learning model having been trained based on the historical characteristic noise patterns identified from the historical sensor data describing physical interactions performed by the authenticated user.

12. The system of claim 11, wherein determining the authentication score based on the physical interaction score and the sensor score comprises:
generating a third input based on the physical interaction score and the sensor score; and
providing the third input into a third machine learning model, yielding the authentication score, the third machine learning model having been trained based on the historical sensor data describing physical interactions performed by the authenticated user and the historical characteristic noise patterns identified from the historical sensor data describing physical interactions performed by the authenticated user.

13. The system of claim 8, wherein determining whether to approve the authentication request based on the comparison of the authentication score to the threshold authentication score comprises:
in response to determining that the authentication score exceeds the threshold authentication score, approving the authentication request.

14. The system of claim 8, wherein determining whether to approve the authentication request based on the comparison of the authentication score to the threshold authentication score comprises:
in response to determining that the authentication score is less than the threshold authentication score, denying the authentication request.

15. A non-transitory computer-readable medium storing instructions that, when executed by one or more computer processors of one or more computing devices, cause the one or more computing devices to perform operations comprising:
receiving sensor data captured by a set of sensors of a client device, the sensor data describing a physical interaction with the client device that was performed as part of an authentication request;
identifying a characteristic noise pattern from the sensor data, the characteristic noise pattern caused by manufacturing deviations of the set of sensors that captured the sensor data;
determining an authentication score based on the sensor data describing the physical interaction with the client device and the characteristic noise pattern, the authentication score indicating a likelihood that the physical interaction was performed by an authenticated user; and
determining whether to approve an authentication request based on a comparison of the authentication score to a threshold authentication score.

16. The non-transitory computer-readable medium of claim 15, wherein determining the authentication score comprises:
determining a physical interaction score based on the sensor data describing the physical interaction with the client device and historical sensor data describing physical interactions performed by the authenticated user;
determining a sensor score based on the characteristic noise pattern identified from the sensor data and historical characteristic noise patterns identified from the historical sensor data describing physical interactions performed by the authenticated user; and
determining the authentication score based on the physical interaction score and the sensor score.

17. The non-transitory computer-readable medium of claim 16, wherein determining the physical interaction score comprises:
generating a first input based on the sensor data describing the physical interaction with the client device; and
providing the first input into a first machine learning model, yielding the physical interaction score, the first machine learning model having been trained based on the historical sensor data describing physical interactions performed by the authenticated user.

18. The non-transitory computer-readable medium of claim 17, wherein determining the sensor score comprises:
generating a second input based on the characteristic noise pattern identified from the sensor data; and
providing the second input into a second machine learning model, yielding the sensor score, the second machine learning model having been trained based on the historical characteristic noise patterns identified from the historical sensor data describing physical interactions performed by the authenticated user.

19. The non-transitory computer-readable medium of claim 18, wherein determining the authentication score based on the physical interaction score and the sensor score comprises:
generating a third input based on the physical interaction score and the sensor score; and
providing the third input into a third machine learning model, yielding the authentication score, the third machine learning model having been trained based on the historical sensor data describing physical interactions performed by the authenticated user and the historical characteristic noise patterns identified from the historical sensor data describing physical interactions performed by the authenticated user.

20. The non-transitory computer-readable medium of claim 15, wherein determining whether to approve the authentication request based on the comparison of the authentication score to the threshold authentication score comprises:
in response to determining that the authentication score exceeds the threshold authentication score, approving the authentication request.
